(19) United States
(12) Patent Application Publication
(10) Pub. No.: US 2022/0234427 A1
(43) Pub. Date: Jul. 28, 2022

(54) COMPOSITE MATERIAL VEHICLE COMPONENT CONSTRUCT

(71) Applicant: Teijin Automotive Technologies, Inc., Auburn Hills, MI (US)

(72) Inventors: Hugh Foran, Auburn Hills, MI (US); Matthew Plauman, Auburn Hills, MI (US); Evan Freeman-Gibb, Auburn Hills, MI (US); Patrick Durham, Auburn Hills, MI (US)

(73) Assignee: Teijin Automotive Technologies, Inc., Auburn Hills, MI (US)

(21) Appl. No.: 17/618,139

(22) PCT Filed: Jun. 11, 2020
(86) PCT No.: PCT/US2020/037167

§ 371 Date: Dec. 10, 2021

Related U.S. Application Data
(60) Provisional application No. 62/859,796, filed on Jun. 11, 2019.

(51) Int. Cl. B60J 5/10; B32B 3/12; B32B 7/12; B32B 27/40; B32B 5/02; B32B 27/28; B29C 70/68

(52) U.S. Cl. CPC B60J 5/107; B29K 2055/02; B32B 7/12; B32B 27/40; B32B 5/024; B32B 27/28; B29C 70/68; B32B 2250/40; B32B 2605/08; B32B 2307/412; B32B 2250/05; B32B 2307/406; B32B 2307/732; B32B 2307/102; B32B 2307/3065; B32B 2307/402; B32B 3/12

(57) ABSTRACT

A vehicle component construct and process of making the same including a frame formed of a composite sandwich panel material and a window formed of a transparent resin within the frame. The composite sandwich panel material of the frame including an open area core defining a plurality of pores, a high gloss surface sheet adhered to a first face of the open area core by a first adhesive layer, and a structural skin adhered to a second face of the open area core by a second adhesive layer. The frame defining a through opening that extends from an exterior surface of the frame to an oppositely opposed interior surface of the frame. The window being formed within the through opening of the frame.

### CROSS-REFERENCE TO RELATED APPLICATION

This application claims priority of U.S. Provisional Patent Application Ser. No. 62/859,796 filed Jun. 11, 2019, which is incorporated herein by reference.

### FIELD OF THE INVENTION

The present invention in general relates to composite materials and in particular to a vehicle door or body component formed with a composite open area core sandwich structure and a window formed of a transparent resin.

### BACKGROUND OF THE INVENTION

Lightweight and heavy duty all terrain and all-purpose vehicles, such as vans and sport utility vehicles have become increasingly popular for both business and personnel use. These vehicles are typically equipped with a liftgate or rear hatch door that opens and closes to expose and enclose a trunk space or cargo compartment of the vehicle. Additionally, some such vehicles include sliding side doors that slide on a track to open and close to expose and enclose portions of the passenger compartment of the vehicle. Typical liftgates, doors, and body panels also form structural body components of the vehicle, providing energy absorption and impact resistance in rear or side impact crashes, respectively. Typical liftgates, doors, and body panels are formed of aluminum or steel, in order to provide the high strength that is required of vehicle structural parts. Typical liftgates, doors, and body panels additionally often include a window through which a driver is able to see. Such windows are formed of glass, such as laminated glass which is formed to two layers of glass with a thin layer of vinyl therebetween. The windows are formed separately and subsequently attached to frame structure that forms the liftgate, door, or body panel.

Weight savings in the automotive, transportation, and logistics-based industries has been a major focus in order to make more fuel-efficient vehicles. In order to achieve weight savings in vehicles, light weight composite materials have been introduced to take the place of typical metal structural and surface body components and panels. Composite materials are materials made from two or more constituent materials with significantly different physical or chemical properties, that when combined, produce a material with characteristics different from the individual components. The individual components remain separate and distinct within the finished structure. A composite material may be preferred for many reasons: common examples include materials which are stronger, lighter, or less expensive when compared to traditional materials.

A sandwich-structured composite is a special class of composite material that is fabricated by attaching two thin but stiff skins to a lightweight but thick core. The core material is normally a low strength material, but its higher thickness provides the sandwich composite with high bending stiffness with overall low density. While sandwich structures have previously been developed to provide strength and reduced weight, the ability to obtain a vehicle exterior quality high gloss surface has remained a challenge, regardless of whether the surface outermost layer is thermoset resin or thermoplastic. Exemplary of these efforts are U.S. Pat. Nos. 5,087,500A; 4,803,108A; 8,091,286B2; 4,369,608A; 3,553,054A; and WO2018/202473. It is conventional to either not use such sandwich structures in settings where vehicle high surface gloss is required, for example, liftgates, doors, and body panels, or resort to an additional outer layer to provide a high gloss outermost layer. Such outermost layers can be applied after structure production or through in mold coatings, both of which add to the cost and complexity of production.

Still another conventional problem with sandwich structures is that the edges are ineffective and allow for infiltration of humidity or moisture that becomes entrained within the core and often inconsistent with finished vehicle surface requirements. With temperature extremes this entrained moisture can reduce the operational lifetime of the structure, while increasing the weight thereof. These problems of moisture infiltration are particularly pronounced in instances when the core is formed of cellulosic materials such as paper. Accordingly, such composite sandwich structures have been unsuitable for forming liftgates and doors given that such areas of a vehicle are exposed to the elements.

Even when liftgates, doors, and body panels are formed of light weight composite materials, the glass window portions are heavy, thereby limiting the amount by which the weight of such components may be reduced. Additionally, the windows being formed separately from the structure of the liftgate, door, or body panel and thus requiring a separate joining or attachment step in order to form a completed liftgate, door, or body panel results in low manufacturing throughputs, added costs, and added tooling.

Thus, there exists a need for a light weight, high strength vehicle component construct formed of light weight composite materials having a window section formed by streamlined manufacturing processes with increased manufacturing throughputs and reduced costs.

### SUMMARY OF THE INVENTION

The present invention provides a light weight, high strength vehicle component construct formed of light weight composite materials having a window section formed by streamlined manufacturing processes with increased manufacturing throughputs and reduced costs. According to embodiments, an inventive vehicle component construct includes a frame formed of a composite sandwich panel material and a window formed of a transparent resin within the frame. The composite sandwich panel material of the frame includes an open area core defining a plurality of pores, a high gloss surface sheet adhered to a first face of the open area core by a first adhesive layer, and a structural skin adhered to a second face of the open area core by a second adhesive layer. The frame defines a through opening that extends from an exterior surface of the frame to an oppositely opposed interior surface of the frame. The window is formed within the through opening of the frame. According to embodiments, the vehicle component construct is a tailgate, liftgate, or hatch door of a vehicle.

The present invention also provides a process for forming the inventive vehicle component construct described. The process includes placing a sheet of the composite sandwich panel material in a mold, cutting the sheet of composite sandwich panel material into a predetermined shape of the frame, and injecting a transparent resin into the mold to form the window in the through opening of the frame.

### BRIEF DESCRIPTION OF THE DRAWINGS

The present invention is further detailed with respect to the following drawings that are intended to show certain aspects of the present invention but should not be construed as a limit on the practice of the present invention.

FIG. 1 is a rear perspective view of a vehicle featuring several embodiments of an inventive vehicle component construct;

FIG. 2 is a rear perspective view of the vehicle of FIG. 1 with a liftgate or tailgate according to embodiments of the present invention in an opened position;

FIG. 3 shows a perspective view of an inventive vehicle component construct according to embodiments of the present invention;

FIG. 4 is a partial cutaway, perspective view of a composite sandwich panel material used to form embodiments of the inventive component construct;

FIG. 5 is an enlarged partial cutaway, side view of the composite sandwich panel material of FIG. 4 along a line bisecting the hexagonal pores;

FIGS. 6A-6D are cross-sectional views of edges of a composite sandwich panel material; and

FIG. 7 is a partial cutaway, perspective view of a composite sandwich panel material containing a conduit used to form embodiments of the inventive component construct.

### DESCRIPTION OF THE INVENTION

The present invention has utility as a light weight, high strength liftgate, door, or body panel construct formed of light weight composite open area core sandwich structure, formed by streamlined manufacturing processes with increased manufacturing throughputs and reduced costs. The use of the composite sandwich structure allows for replacement of traditional materials such as steel or aluminum, without a loss of strength. Additionally, the present invention has utility as a liftgate, door, or body panel construct having a transparent window section simultaneously formed therein to further reduce the weight of the liftgate, door, or body panel construct while also improving manufacturing cycle time and throughput.

According to embodiments, a liftgate, door, or body panel construct is formed of a sandwich composite structure as detailed in co-pending U.S. Provisional Patent Application No. 62/774,600, filed on Dec. 3, 2018, the contents of which are hereby incorporated by reference. As described therein, embodiments of the sandwich composite structure provide a high gloss surface sheet and structural skin that are adhered to the open area core with an adhesive or glue that is viscous when applied. The viscosity of the adhesive as applied allows for contact with the interior volume of the open area core to create more adhesion surface area yet without excessively running into the pores defined in the open area core before the adhesive cured or hardens thereby providing greater adhered contact area between the components of the sandwich composite structure. As a result, reduced delamination of the components of the sandwich composite structure is observed as well as precluding bond line readthrough into the high gloss surface sheet. It is appreciated that providing a high gloss exterior surface without resort to an additional outmost layer requires a balancing of opposing surface tension properties of the composite sandwich panel structures to avoid a loss in tolerances associated with bowing of the structure. Embodiments of the present invention also have utility as watertight and waterproof composite sandwich panel structures.

The present invention will now be described with reference to the following embodiments. As is apparent by these descriptions, this invention can be embodied in different forms and should not be construed as limited to the embodiments set forth herein. Rather, these embodiments are provided so that this disclosure will be thorough and complete, and will fully convey the scope of the invention to those skilled in the art. For example, features illustrated with respect to one embodiment can be incorporated into other embodiments, and features illustrated with respect to a particular embodiment may be deleted from the embodiment. In addition, numerous variations and additions to the embodiments suggested herein will be apparent to those skilled in the art in light of the instant disclosure, which do not depart from the instant invention. Hence, the following specification is intended to illustrate some particular embodiments of the invention, and not to exhaustively specify all permutations, combinations, and variations thereof.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

Unless indicated otherwise, explicitly or by context, the following terms are used herein as set forth below.

As used in the description of the invention and the appended claims, the singular forms “a,” “an” and “the” are intended to include the plural forms as well, unless the context clearly indicates otherwise.

Also as used herein, “and/or” refers to and encompasses any and all possible combinations of one or more of the associated listed items, as well as the lack of combinations when interpreted in the alternative (“or”).

As used herein, the term “high gloss surface” refers to a surface having minimal perceptible surface defects when visually inspected for about three seconds from about 24-28 inches from the viewer and normal to the part surface +/−90 degrees in a well-lit area. That is, the term “high gloss surface” refers to a surface capable of being painted and accepted as a “Class A” autobody part. This is commonly measured by ASTM D523. In the automotive industry, a Class A surface is a surface a consumer can see without functioning the vehicle (e.g., opening the hood or decklid), while a Class A surface finish generally refers to painted outer panels and specifically to the distinctness of image (DOI) and gloss level on the part. It is appreciated that a surface layer may be subjected to sanding, trimming, and priming prior to receiving a paint coating that imparts high gloss, yet must retain dimensionality and adhesion uniformity to primer and paint so as to achieve a high gloss finish.

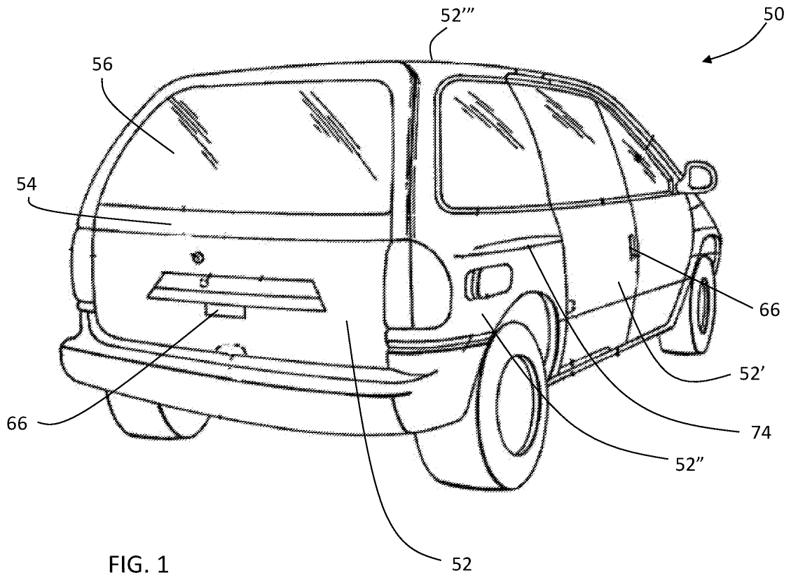

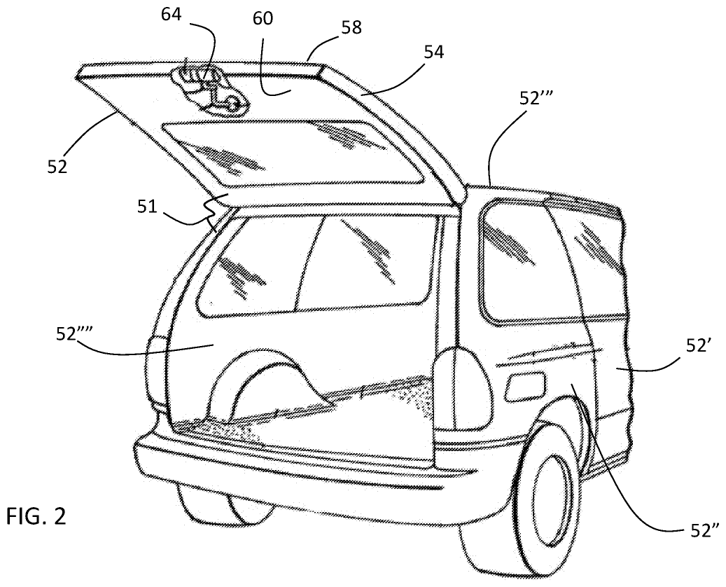

FIGS. 1 and 2 show rear perspective views of a vehicle 50 featuring several embodiments of an inventive vehicle component construct 52, 52′, 52″, 52′″, 52″″. According to embodiments, the inventive vehicle component construct is a tailgate, liftgate, or hatch door 52; a sliding door 52′; a body panel 52″, 52″″; or a roof panel 52′″, for example having a moon roof. For the sake of clarity in the figures, reference numerals regarding the features of embodiments of the inventive vehicle component construct are generally shown with regard to vehicle component construct 52, unless otherwise indicated; however, it will be understood that the described and referenced features may be present in all of the embodiments of the inventive vehicle component construct 52, 52′, 52″, 52′″, 52″″. According to embodiments, an inventive vehicle component construct includes a frame 54 formed of a composite sandwich panel material 10 and a window 56. The frame 54 has an exterior surface 58 and an oppositely opposed interior surface 60. The frame 54 defines a through opening 62 therein that extends from the exterior surface 58 of the frame 54 to the interior surface 60 of the frame 54. The window 56 is formed within the through opening 62 of the frame 54. The window 56 is formed of a transparent material, such as a transparent resin or glass

According to embodiments, the window 56 is formed by injection molding. In such embodiments, a transparent resin that forms the window 56 is injected into a mold, preferably the same mold that is used to form the shape of the frame 54. Thus, the entire vehicle component construct is capable of being formed as a single unit from a single mold or manufacturing device. This presents significant time and monetary savings for manufacturers.

According to embodiments, the transparent resin of the window 56 is a thermoplastic resin having high impact resistance and toughness, such as acrylonitrile butadiene styrene (ABS). Additionally, the window 56 formed by a resin is significantly lighter in weight than a typical glass window, thereby significantly reducing the weight of the vehicle component construct. According to embodiments, the ABS resin includes from 15 to 35% acrylonitrile, 5 to 30% butadiene, and 40 to 60% styrene. Components formed from ABS resin have high impact resistance and toughness, making ABS particularly well suited for forming a vehicle window. The transparent resin can be tuned to improve impact resistance, toughness, and heat resistance. For example, impact resistance can be amplified by increasing the proportions of polybutadiene in relation to styrene and also acrylonitrile, although this causes changes in other properties. Impact resistance does not fall off rapidly at lower temperatures. The transparent resin can be further tuned by modifying the conditions under which the material is processed to the final product. For example, molding at a high temperature improves the gloss and heat resistance of the product whereas the highest impact resistance and strength are obtained by molding at low temperature. Fibers (usually glass fibers) and additives can be mixed in the resin pellets to make the final product strong and raise the maximum operating temperature as high as 80° C. (176° F.). According to embodiments, particles are added to the transparent resin such that the window 56 is tinted to provide UV protection within the vehicle. According to embodiments, additives are provided in the transparent resin to increase the window's 56 ability to withstand the harmful effects of ultraviolet radiation.

According to embodiments, the window 56 is formed of glass. In such embodiments, a glass window 56 may be positioned in such a way that the frame 54 is molded around the glass window 56. Alternatively, the glass window 56 is bonded to a lip that surrounds the through opening 62 formed in the frame 54.

According to embodiments, the window 56, formed of either glass or a transparent resin, includes window defroster elements that are molded into the window 56. According to embodiments, the window defroster elements are a plurality of wires that are configured to be electrically heated such that any frost, fog, or ice that forms on the window 56 can be removed by the heating of the wires. According to embodiments, the window defroster elements of the window 56 include a connector that is positioned outside of the window 56. The connector is configured to be connected with a corresponding connector positioned on the frame 54.

As noted above, the frame 54 is formed of a composite sandwich panel material 10. The composite sandwich panel material 10 includes an open area core 12 with walls 26 defining an ordered array of pores 24 terminating in faces 17 and 17′, a high gloss surface sheet 14 adhered to a first face 17 of the open area core 12 by a first adhesive layer 20, and a structural skin 16 adhered to a second face 17′ of the open area core 12 by a second adhesive layer 22. The high gloss surface sheet 14 has a high gloss finish suitable as an auto body exterior surface. According to embodiments, the exterior surface 58 of the frame 54 is defined by the high gloss surface sheet 14 of the composite sandwich panel material 10 and the oppositely opposed interior surface 60 of the frame 54 is defined by the structural skin 16 of the composite sandwich panel material 10. Thus, the frame 54 is formed as a structural part and simultaneously as a decorative part with no additional high gloss panel separate from the frame 54 being needed to complete the vehicle component.

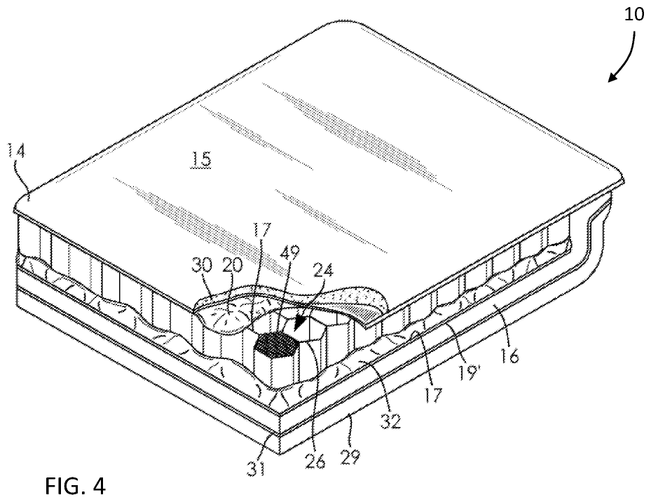

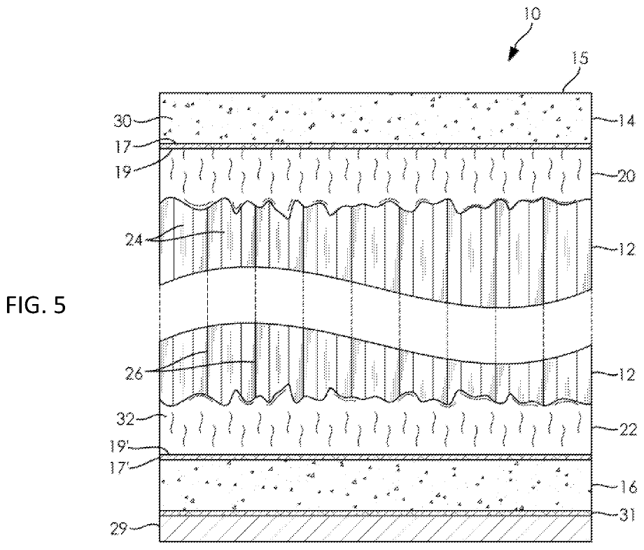

As shown in FIG. 4, a portion of the surface sheet 14 is cutaway to reveal the adhesive 20, a cloth, if present; and the open area core 12. The surface sheet 14 is adhered to a first side of the open area core 12 by a first adhesive layer 20. According to embodiments, the surface sheet 14 presents an outwardly facing high gloss surface 15. FIG. 5 is an enlarged cross-sectional view of a composite sandwich panel material 10 used to form the inventive vehicle component construct 52 according to embodiments of the invention. FIG. 5 shows further details of the various layers making up the composite sandwich panel material 10. In some embodiments, a cloth 19 is present intermediate between the face 17 of the open area core 12 and the surface sheet 14, the cloth 19 being embedded within the adhesive 20. The structural skin 16 is adhered to an opposing second side of the open area core 12 by a second adhesive layer 22. In some embodiments, a cloth 19′ is present intermediate between the face 17′ of open area core 12 and the structural skin 16, the cloth 19′ being embedded within the adhesive 22.

According to embodiments, the open area core 12 is formed of a lightweight material that defines a plurality of pores 24 so as to reduce the overall density of the open area core 12. The open area core 12 is formed from a variety of materials that include cellulosics such as corrugated fiberboard, paper board, paper stock; thermoplastics such as poly(methyl methacrylate) (PMMA), acrylonitrile butadiene styrene (ABS), polyamides, polylactides, polybenzimidazoles, polycarbonates, polyether sulfones, polyethylene, polypropylene, polystyrene, polyvinyl chloride, and block copolymers of any one of the aforementioned where at least one of the aforementioned makes up the majority by weight of the copolymer and regardless of the tacticity of the polymer or copolymer; thermosets such as polyesters, polyureas, polyurethanes, polyurea/polyurethanes, epoxies, vinyl esters; metal such as aluminum, magnesium, and alloys of any one of the aforementioned where at least one of the aforementioned metals constitutes the majority by weight of the alloy; a foam formed from polyurethane, polyethylene, ethylene vinyl acetate, polypropylene, polystyrene, polyvinyl chloride, oraerogels, regardless of whether the foam is open-celled or closed-celled. The top edges of the walls 26 that define the pores 24 in certain embodiments of the open area core such as 12 form an array of various shapes, such as hexagonal, circular, rhomboidal, triangular, parallelogram quadrilateral, and regular quadrilateral, honeycombs, diamonds, squares, triangles, parallelograms, circles, or a combination thereof. In some embodiments, the ratio of the thickness of a wall 26 to the maximal linear extent between faces 17 and 17′ is between 0.01-10:1. A wall thickness ranges from 0.1 mm to 100 mm in such embodiments.

The adhesive layers 20, 22 are formed of either a thermoplastic or curable formulation, a polyurethane or polyurethane prepolymer adhesive, which may be in the form of glue, a moisture cure adhesive, a reactive hot melt adhesive, or a polyurethane resin. As shown in FIG. 5, due to the compressive force applied to the adhesive layers 20, 22 between the surface sheet 14 and the open area core 12 and the structural skin 16 and the open area core 12, the adhesive 20, 22 is engineered to have an initial viscosity on contact with the face 17 and the walls 26 so as partially fill the pores 24 of the open area core 12. The viscosity of the adhesive layers 20, 22 ensures that the adhesive does not excessively run into the pores defined in the open area core before the adhesive attains final strength. Accordingly, the adhesive surface area for adhesion between a surface sheet and structural skin and the open area core is at least 5% more than surface area of the walls at the face. This increased surface area of adhesion reduces delamination of the components of the composite sandwich 10 and surprisingly allows for the use of thinner surface sheets that do not exhibit bond line read through. As a result of increasing the adhesive surface area coverage from 10 to 50 surface area percent allows for the comparatively expensive high gloss surface sheet to be reduced in thickness from 1.5 mm to between 1.3 and 0.8 mm while still preventing of bond line read through.

The high gloss surface sheet 14 of the composite sandwich panel 10 is formed from sheet molding compound (SMC), thermoplastic, dicyclopentadiene (DCPD), overmolded polyurethane (PU), or a combination thereof. According to embodiments, the surface sheet 14 is a high gloss surface sheet having a high gloss surface 15. The surface sheet 14 can include a filler material 30 to reinforce and/or serve to decrease the weight of the high gloss surface sheet 14. The filler material 30 is any of glass fibers, carbon fibers, natural fibers, hollow or solid glass microspheres, or a combination thereof. The fibers may be oriented or non-oriented. In some inventive embodiments in which SMC forms the high gloss surface, a resin package sold by Continental Structural Plastics, Inc. under the tradenames TCA® and TCA® ULTRA-LITE™ are used herein. Exemplary formulations of which are detailed in U.S. Pat. No. 7,700,670; WO2017/184761; and U.S. Pat. No. 7,524,547B2. It is appreciated that the high gloss sheet routinely includes additives to retain dimensionality. Such additives routinely including glass fiber; carbon fiber; inorganic particulate fillers such as calcium carbonate, talc, and carbon black; glass microspheres; carbon nanotubes; graphene; low profile additives; moisture scavengers; and combinations thereof. Typical thicknesses of the high gloss surface sheet in the present invention range from 0.5 to 5 millimeters (mm) without regard to edges.

According to embodiments, a colorant is added to the sheet molding compound (SMC), thermoplastic, dicyclopentadiene (DCPD), overmolded polyurethane (PU), or a combination thereof that forms the high gloss surface sheet 14 of the composite sandwich panel 10. Thus, the exterior surface 58 of a frame 54 formed of such a composite sandwich panel 10 is provided with the color of the vehicle exterior, thereby eliminating additional component finishing processes, such as priming and painting.

As will be understood by a person having ordinary skill in the art, the high gloss surface sheet tends to be a comparatively dense component and an expensive portion to manufacture given the materials used and necessary forming processes to maintain minimal perceptible surface defects suitable for a Class A autobody part. To reduce costs and weight of the composite sandwich panel material 10, it is accordingly desirable to reduce the thickness of the high gloss surface sheet 14, making it as thin as possible. It will also be understood that as the thickness of the high gloss surface sheet 14 is decreased the high gloss surface sheet 14 tends to deform when supported by limited portions of the face 17 above the open area core 12. While result to a large contact surface area of the first adhesive layer 20 is advantageous, in some inventive embodiments a cloth 19 is embedded in the first adhesive layer 20.

The structural skin 16 is adhered to the second side of the open area core 12 by the second adhesive layer 22. The structural skin 16 is formed of a fiber mat having non-oriented, non-woven fibers, unidirectional, or woven fibers, a thermoplastic sheet, or an SMC. The structural skin 16 provides a robust and durable surface. In some embodiments, the structural skin 16 terminates against the backside of the surface sheet 14 to encapsulate the open area core 12.

According to certain embodiments, the composite sandwich panel material 10 provides sound damping, fire retardancy, thermal insulation, or a combination thereof by placing a sound and/or heat absorbing material within the pores 24 of the open area core 12. According to embodiments, the pores 24 of the open area core 12 are at least partially filled with a fill 49. The fill illustratively including foam pellets, fire retardant, or a phase change material. Phase change materials operative herein include waxes or an inorganic salt hydrates.

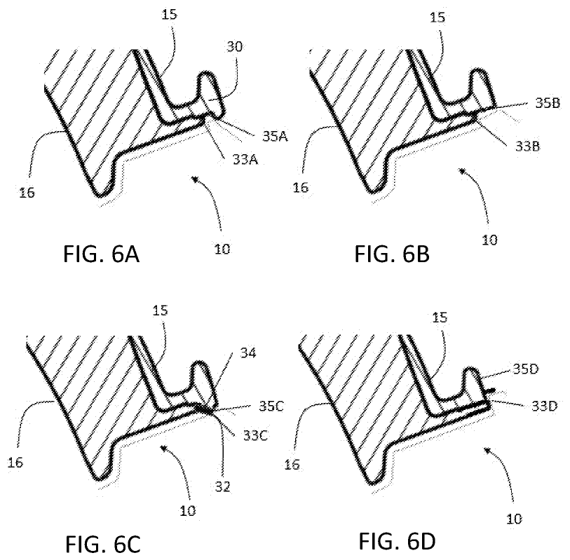

The surface sheet 14 and the structural skin 16 are joined together along an edge 33A-33D of the composite sandwich panel material 10 to form a seal, as shown in FIGS. 6A-6D, respectively. In certain embodiments in which all of the edges of the composite sandwich panel assembly 10 are sealed, the open area core 12 is fully enclosed and moisture is inhibited from entering the interior of the composite sandwich panel assembly 10. Given that the components of the inventive vehicle component construct 52 formed of the composite sandwich panel assembly 10 are exposed to natural elements including sun, snow, humidity, and rain, preventing moisture from entering the interior of the composite sandwich panel material 10 is important given that freeze thaw cycles of moisture within the part cause expansion and potentially failure of the composite sandwich panel material 10, leading to damage to the vehicle component construct 52. Additionally, in embodiments in which the open area core 12 is formed of a hydrophilic material such as paper, moisture within the composite sandwich panel assembly 10 would destroy the open are core 12 and cause the part to fail.

FIGS. 6A-6D show various embodiments of ways in which the surface sheet 14 and the structural skin 16 are joined together to form a sealed edge 33A-33D, respectively according to the present disclosure. In some inventive embodiments an elastomeric gasket 34 is disposed between the surface sheet 14 and the structural skin 16 at the 33C to make the edge 33C more water resistant. It is appreciated that a gasket is readily included in the other edge joinder 33A, 33B, and 33D. The gasket 35 enhances maintenance of the edge seal over a wider range of use conditions.

As will be understood by one having ordinary skill in the art, to form an edge seal between the surface sheet 14 and the structural skin 16, at least one of the surface sheet 14 and the structural skin 16 requires enough material to wrap around the edge of the composite sandwich 10. According to embodiments, at least one of the surface sheet 14 and the structural skin 16 is provided in dimensions greater than the dimensions of the final composite part such that the material is able to wrap around the final edge composite sandwich 10. According to certain embodiments, the at least one of the surface sheet 14 and the structural skin 16 is preformed such that it has edges extending generally perpendicularly from the plane of the sheet material.

According to embodiments, excess material is cut from the composite sandwich once the edge seal is formed. As shown in FIG. 6A, excess material of the structural skin 16 has been trimmed from the composite sandwich assembly 10 by a knife or router that presses against the divot 35A that is formed by the surface sheet 14. In FIG. 6B, the edge 33B formed by removing excess material for tool engagement against a shoulder 35B of the surface sheet 14. In FIG. 6C, the edge 33C formed by removing excess material for tool engagement against a shoulder 35C of the surface sheet 14. Also, as shown in FIG. 6D, excess material of one or both the surface sheet 14 and the structural skin 16 are trimmed with tool pressure against shoulder 35D.

Given that the surface sheet 14 and the structural skin 16 of the composite sandwich panel material 10 are joined together to form sealed edges 33A-33D, thereby protecting the open area core 12 within the surface sheet 14 and the structural skin 16, the frame 54 of an inventive vehicle component construct 52, 52′, 52″, 52′″, 52″″ according to embodiments is submerged in paint for finishing. According to embodiments, the frame 54 is e-coated, that is the frame 54 is submerged in an electrically charged coating that is attracted to the frame 54 to evenly coat the frame.

Referring again to FIGS. 1-3, embodiments of an inventive vehicle component include a tailgate, liftgate, or hatch door 52; a sliding door 52′; a body panel 52″, 52″″; or a roof panel 52′″, for example having a moon roof. According to embodiments, a tailgate, liftgate, or hatch door 52 or a sliding door 52′ include a locking mechanism 64. The locking mechanism 64 is positioned on the interior surface 60 of the frame 54 that is defined by the structural skin 16 of the composite sandwich panel material 10. According to embodiments, the locking mechanism is attached to the frame 54 after the frame 54 is shaped and formed, which may include cutting an opening in the interior surface 60 of the frame that corresponds to the shape and desired location of the locking mechanism 64. The locking mechanism 64 may include a latch and a catch that are configured to cooperate with one another in order to hold the tailgate, liftgate, or hatch door 52, or sliding door 52′ in a closed position relative to the vehicle frame.

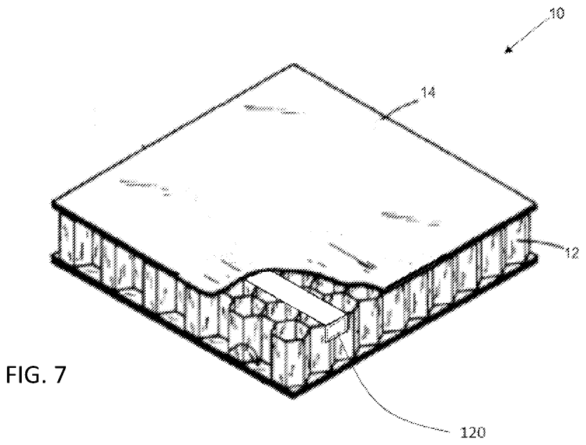

As shown in FIG. 7, embodiments of an inventive tailgate, liftgate, or hatch door 52; a sliding door 52′; a body panel 52″, 52″″; or a roof panel 52′″ include a conduit system 120 embedded within the composite sandwich panel material 10 of the frame 54 of each vehicle component. As shown in FIG. 7, the conduit system 120 is embedded in the open area core 12 of composite sandwich panel assembly 10 that forms the frame 54 of the inventive tailgate, liftgate, or hatch door 52; a sliding door 52′; a body panel 52″, 52″″; or a roof panel 52′″. According to embodiments, the conduit system 120 comprises tubing or wires that are molded into the open area core 12 of the composite sandwich 10 before the frame 54 of a vehicle component is formed. According to embodiments, the conduit system 120 includes electrical wiring, ventilation ducts, or heating elements. Accordingly, embodiments of the inventive tailgate, liftgate, or hatch door 52; a sliding door 52′; a body panel 52″, 52″″; or a roof panel 52′″ are capable of including features such as speakers, lights, air vents for regulating the climate within the vehicle, and defrosting elements for removing ice or snow present on the vehicle component or the window formed therein. The conduit systems 120 of various vehicle components are configured to align with one another to form a single connected conduit system throughout the vehicle to connect electrical wiring, ventilation ducts, and/or heating elements of each of an inventive tailgate, liftgate, or hatch door 52; a sliding door 52′; a body panel 52″, 52″″; or a roof panel 52′″ with like electrical wiring, ventilation ducts, and/or heating elements of the vehicle to function.

According to embodiments, a tailgate, liftgate, or hatch door 52 or a sliding door 52′ include a handle 66. The handle 66 is positioned on the exterior surface 58 of the frame 54 that is defined by the high gloss surface sheet 14 of the composite sandwich panel material 10. According to embodiments, the handle 66 is attached to the frame 54 after the frame 54 is shaped and formed, which may include drilling attachment holes in the exterior surface 58 of the frame that corresponds to the shape and desired location of the handle 66.

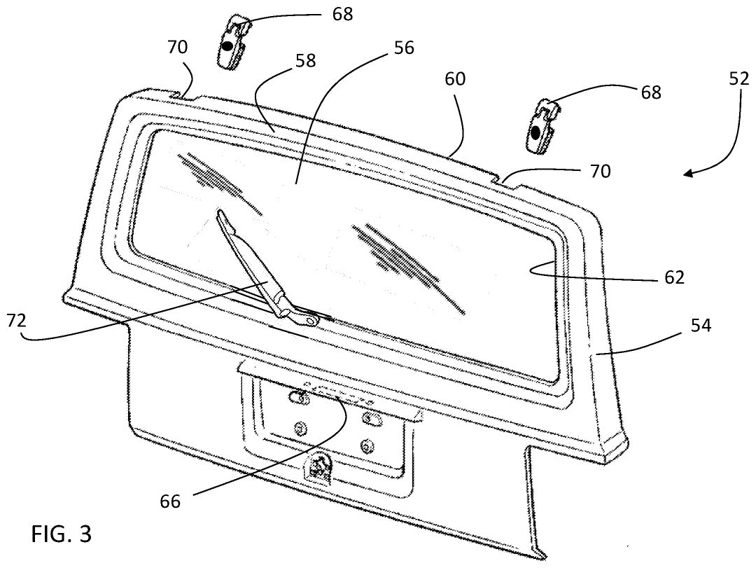

According to embodiments, a tailgate, liftgate, or hatch door 52 include a plurality of hinges 68 that movably attach the tailgate, liftgate, or hatch door 52 to the vehicle frame. According to embodiments, the hinges 68 are attached to the interior surface 60 of the frame 58 of the composite construct. According to embodiments, the frame includes a plurality of cutouts 70 that correspond in shape and desired location to the hinges 68. Such cutouts 70 are formed in the frame 54 by either cutting the cutouts 70 out from the material of the frame 54 or by forming the cutouts 70 in the frame by molding when the frame 54 is formed. According to embodiments, the cutouts 70 are positioned along an upper or top edge of the frame 54, as shown in FIG. 3. In such a case, the tailgate, liftgate, or hatch door 52 pivots about the hinges 68 to move upward to an open position, as shown in FIG. 2. According to embodiments, the hinges are positioned along a side edge of the frame 54, such that the tailgate, liftgate, or hatch door 52 pivots about the hinges 68 to move upward to an open position.

According to embodiments, a tailgate, liftgate, or hatch door 52 includes a wiper blade 72 pivotably mounted to the exterior surface 60 of the frame 54. The wiper blade 72 is configured to engage with the window 56 to wipe liquid, debris, and dirt from the surface of the window 56. According to embodiments, the wiper blade 72 is attached to the frame 54 after the frame 54 is formed. Accordingly, attaching the wiper blade 72 may include drilling an attachment hole into the exterior surface 58 of the frame 54 and attaching the wiper blade 72 thereto with a fastener.

As shown in FIG. 2, embodiments of a tailgate, liftgate, or hatch door 52 includes a safety cable 51 that is configured to be attached between the tailgate, liftgate, or hatch door 52 and the vehicle body. According to embodiments, the safety cable 51 is embedded in the tailgate, liftgate, or hatch door 52 at a first end of the safety cable 51 and is attachable at the opposite end of the safety cable 51 to the frame of the vehicle body. The safety cable 51 thus connects the tailgate, liftgate, or hatch door 52 to the vehicle body at a point in addition to the hinges 68. Thus, in the event of a crash or failure of the hinges 68, the tailgate, liftgate, or hatch door 52 is remains connected to the vehicle body. According to embodiments, a vehicle component construct, such a sliding door 52′, includes a roller system (not shown) positioned on the interior surface 60 of the frame 54. The roller system is configured to glide in a track 74 positioned on or formed in an exterior surface 58 of a body panel 52″ of the vehicle 50.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention but is not meant to be a limitation upon the practice thereof. The following claims, including all equivalents thereof, are intended to define the scope of the invention.

1. A vehicle component construct comprising:
a frame formed of a composite sandwich panel material comprising an open area core defining a plurality of pores, a high gloss surface sheet adhered to a first face of the open area core by a first adhesive layer, and a structural skin adhered to a second face of the open area core by a second adhesive layer, said frame defining a through opening extending from an exterior surface of said frame to an oppositely opposed interior surface of said frame; and
a window formed within the through opening of said frame, said window formed of a transparent resin.

2. The vehicle component construct of claim 1 wherein the exterior surface of said frame is defined by the high gloss surface sheet of said composite sandwich panel material and the oppositely opposed interior surface of said frame is defined by the structural skin of said composite sandwich panel material.

3. The vehicle component construct of claim 1 wherein said vehicle component construct is a body section of a vehicle.

4. The vehicle component construct of claim 1 further comprising at least one of a locking mechanism positioned on the interior surface of said frame, a handle positioned on the exterior surface of said frame, a plurality of hinges attached to the interior surface of said frame, a wiper blade pivotably mounted to the exterior surface of said frame, said wiper blade configured to engage with said window, a roller system positioned on the interior surface of said frame, said roller system configured to glide in a track positioned on an exterior surface of the vehicle, and a decorative layer attached to said structural skin.

5. The vehicle component construct of claim 1 wherein the transparent resin is Acrylonitrile butadiene styrene (ABS).

6. The vehicle component construct of claim 1 wherein the open area core of said composite sandwich panel material is an array.

7. The vehicle component construct of claim 1 wherein the open are core of said composite sandwich panel material is formed of at least one of: cellulosics, thermoplastic, thermoset, metal, or foam.

8. The vehicle component construct of claim 1 wherein the high gloss surface sheet of said composite sandwich panel material is formed of any one of: sheet molding compound (SMC), thermoplastic sheet, dicyclopentadiene (DCPD), or overmolded polyurethane (PU).

9. The vehicle component construct of claim 1 wherein the high gloss surface sheet of said composite sandwich panel material comprises a filler.

10. The vehicle component construct of claim 1 wherein the high gloss surface sheet of said composite sandwich panel material comprises a colorant.

11. The vehicle component construct of claim 1 wherein the high gloss surface sheet of said composite sandwich panel material has a thickness of from 0.5 to 3.5 mm.

12. The vehicle component construct of claim 1 wherein said composite sandwich panel material has a ratio of a thickness of the high gloss surface sheet to a thickness of the open area core of 0.01-1:1.

13. The vehicle component construct of claim 1 wherein said composite sandwich panel material has a cloth intermediate between the high gloss surface sheet and the open area core.

14. The vehicle component construct of claim 1 wherein the first adhesive layer of said composite sandwich panel material contacts an interior volume of the open area core.

15. The vehicle component construct of claim 1 wherein the structural skin is formed of a fiber mat.

16. The vehicle component construct of claim 1 wherein the first adhesive layer of said composite sandwich panel material and the second adhesive layer of said composite sandwich panel material each independently are a polyurethane or polyurethane prepolymer, a moisture cure adhesive, a reactive hot melt adhesive, or polyurethane resin.

17. The vehicle component construct of claim 1 wherein said composite sandwich panel material has a fill in the pores of the open area core, the fill being at least one of a sound dampening foam, a fire retardant, or a phase change material.

18. The vehicle component construct of claim 1 wherein the high gloss surface sheet of said composite sandwich panel material and the structural skin of said composite sandwich panel material are joined together to form an edge defining a moisture resistant seal.

19. The vehicle component construct of claim 18 further comprising a gasket disposed between the high gloss surface sheet of said composite sandwich panel material and the structural skin at the edge.

20. A process for forming the vehicle component construct of claim 1 comprising:
placing a sheet of said composite sandwich panel material in a mold;
cutting said sheet of said composite sandwich panel material into a predetermined shape of said frame; and
injecting said transparent resin into the mold to form said window in the through opening of said frame.
